(19) United States
(12) Patent Application Publication
(10) Pub. No.: US 2008/0166168 A1
(43) Pub. Date: Jul. 10, 2008

(54) Method And Device For Reducing The Number Of Actions Required To Operate A computer Or Other Device

(76) Inventor: Ernest Victor Glover, Baltimore, MD (US)

Correspondence Address: ERNEST V. GLOVER, SR., 2953 BRIGHTON, BALTIMORE, MD, 21216-3910, US

(21) Appl. No.: 11/617,780

(22) Filed: Dec. 29, 2006

(51) Int. Cl. B41J 5/00

(52) U.S. Cl. 400/486

(57) ABSTRACT

The present invention is a method and embodied keyboard that does not require the use of the Shift key to produce character output to a computer system. It has the ability to produce a group of characters such as whole words and/or partial words with a single key press. It is an Assistive Technology Device (ATD) for people with physical and/or learning disabilities. The present invention is especially useful when used in situations that do not require high-speed data input.

### RELATED APPLICATIONS

Disclosure Document No. 601505 dated May 31, 2006: Device For Reducing The Number of Actions Required By A Disabled Person To Operate A Computer

### BACKGROUND OF THE INVENTION

1. Field of the invention

The present invention relates to the field of Assistive Technology Devices (ATDs) for people with physical and/or learning disabilities, and specifically to keyboards.

2. Discussion of Prior Art

A keyboard is a lot like a miniature computer. It has its own Processor and circuitry that carries information to and from that Processor. There is also Memory that contains a Character Map as well as Memory containing processing instructions (the operating program). Also, the keyboard has circuitry called the Key Matrix.

The Key Matrix is a grid of circuits underneath the keys. When you press a key, it presses a switch, completing a circuit and allowing a tiny amount of current to flow through.

When the Processor finds a circuit that is closed, it compares the grid location of that circuit on the Key Matrix to the Character Map in its memory. A Character Map is basically a comparison chart or lookup table. It tells the Processor the position of each key in the Key Matrix and what each key press or combination of key presses represent. For example, the Character Map lets the Processor know that pressing a letter key by itself corresponds to a lowercase letter, but the Shift key and a letter key pressed together corresponds to an uppercase letter. Once the Processor retrieves the information from Character Map, it then outputs the corresponding code to the computer.

There are a variety of disabilities which make it difficult or impossible for some people to use a standard keyboard. For example, people with physical disabilities such as missing fingers, or reduced mobility in their hands due to joint problems such as arthritis, find it very difficult, if not impossible, to operate computers. That is because the primary input device—the keyboard—is designed for two-hands, ten-fingers operation. An example of that is the use of key combinations to produce an output, such as simultaneously pressing the Shift key plus the number four (4) key to produce the dollar ($) symbol. Ergonomic keyboards and alternative keyboards designed for use by disabled persons also use key combinations as part of their operation.

The requirement for speed and efficiency in an office environment can cause physical problems to an operator. Prolonged bending, flexing, rotating and stretching of the fingers and wrists to press keys can cause a Repetitive Stress Injury (RSI) such as Carpal Tunnel Syndrome. Ergonomic keyboards were designed to help reduce those types of injuries. There are many different approaches to addressing the problem, such as re-aligning the keys such that they fit into a curved layout, or splitting the keyboard into left- and right -hand sections. However, none of the approaches significantly affect a major cause of injury: the high volume of key presses. Being able to produce the same number of words while using less key presses is a useful goal. The X-Keys keypads from PI Engineering is an attempt at lowering the number of key presses. The keypads allows output of words, phrases and commands using a single key press. However, the X-Keys keypads are not full keyboards; they must be used in addition to the users regular keyboard. Also, the X-Keys keypads require programming by the user.

Finally, most keyboards like the standard QWERTY and the alternative Dvorak have a confusing visual key layout. The keys are not in the order most people expect; that is, they are not in the A-B-C-D order which is the way most of us were taught to memorize our alphabet. Other layouts include XPeRT, QWERTZ and AZERTY. Each is named for the first keys in the pattern. People with a visual disability such as Dyslexia often have trouble understanding the layout of the keys. Also, some non-disabled people are simply intimidated by the total visual impact of the keyboard layout and, therefor, will shy away from using a computer.

### OBJECTS

It is an object of the present invention to provide a method for eliminating the need for using a Shift key to input data to a computer.

An additional object of the present invention is to reduce the number of key presses required to produce keyboard output by allowing whole words and/or partial words such as word endings to be produced with a single key press.

Another object of the present invention is to reduce the visual confusion associated with the key layout of current keyboards.

A further object of the present invention is that it have the ability to be used with any computer system without requiring special programming or modification of the computer system.

### BRIEF SUMMARY OF THE INVENTION

A methodology for eliminating the need to use the Shift key to produce character output to a computer or other device is described herein. The method is embodied by a keyboard which has individual keys for each character to be outputted by the keyboard. That includes separate keys for uppercase letters and for lowercase letters. The keyboard also has keys for producing whole words and/or partial words such as word endings using a single key press.

### BRIEF DESCRIPTION OF THE DRAWINGS

FIG. 1, Current Method, is a simplified flowchart for producing an uppercase letter using a standard keyboard.

FIG. 2, Present Invention Method, is a simplified flowchart for producing an uppercase letter using the present invention keyboard.

FIG. 3, Present Invention Method, Leading-uppercase word, is a simplified flowchart for producing whole words.

FIG. 4, Present Invention Method, Partial Word (suffix) is a simplified flowchart for producing partial words such as word endings (suffixes).

FIG. 5, Preferred Embodiment, is a sample partial keyboard indicating the keyboard layout of the present invention, and a cutaway view indicating some internal parts of the present invention keyboard.

FIG. 6, Rocker, is a picture of a rocker type switch.

FIG. 7, Toggle, is a picture of a toggle type switch.

### DETAILED DESCRIPTION OF THE INVENTION

The present invention will be described in detail referring to the attached drawings. The preferred embodiment and some additional embodiments are described here, but the scope of the present invention is not limited to the descriptions contained herein. Also, the word character as used herein includes the letters of an alphabet, numbers, punctuation marks and symbols.

### Operation

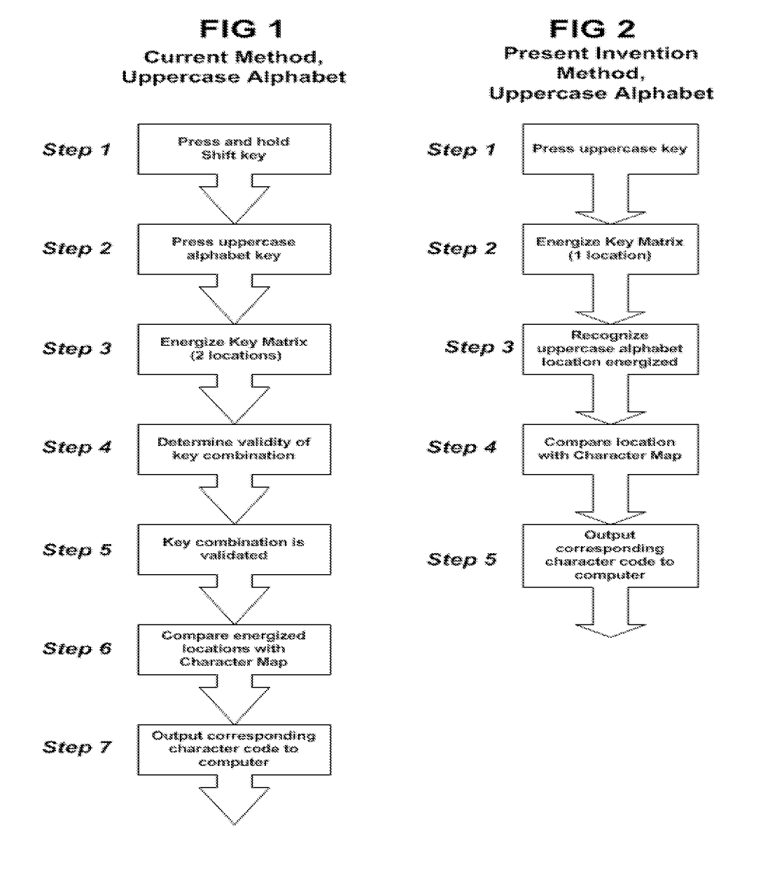

Referring to FIG. 1, Current Method, Uppercase alphabet, to output an uppercase alphabet character requires the following steps: When the Shift key is pressed Step 1 in combination with a alphabet character key on the keyboard Step 2, it energizes two locations on the Key Matrix, Step 3; one for the Shift key and another for the alphabet character key. The Processor recognizes that two key locations have been energized, and checks if the key combination is a valid one Step 4. The keyboard Processor determines that the Shift key location and an alphabet character key location have been energized, and is a valid combination Step 5. The Processor operating program compares the two locations to a table in the Character Map Step 6 and identifies the correct output. The Processor then outputs the corresponding character code for that uppercase alphabet character to the computer Step 7.

Referring to FIG. 2, Present Invention Method, Uppercase alphabet, to output an uppercase alphabet character requires the following steps: An uppercase alphabet character key is pressed Step 1 which then energizes a location on the Key Matrix Step 2. The Processor recognizes that an uppercase alphabet character key location has been energized Step 3. The Processor operating program then compares that location to a table in the Character Map Step 4 and identifies the correct output. The Processor then outputs the corresponding character code for that uppercase alphabet character to the computer Step 5.

The present invention Processor program uses less steps than prior and current art to produce the same output.

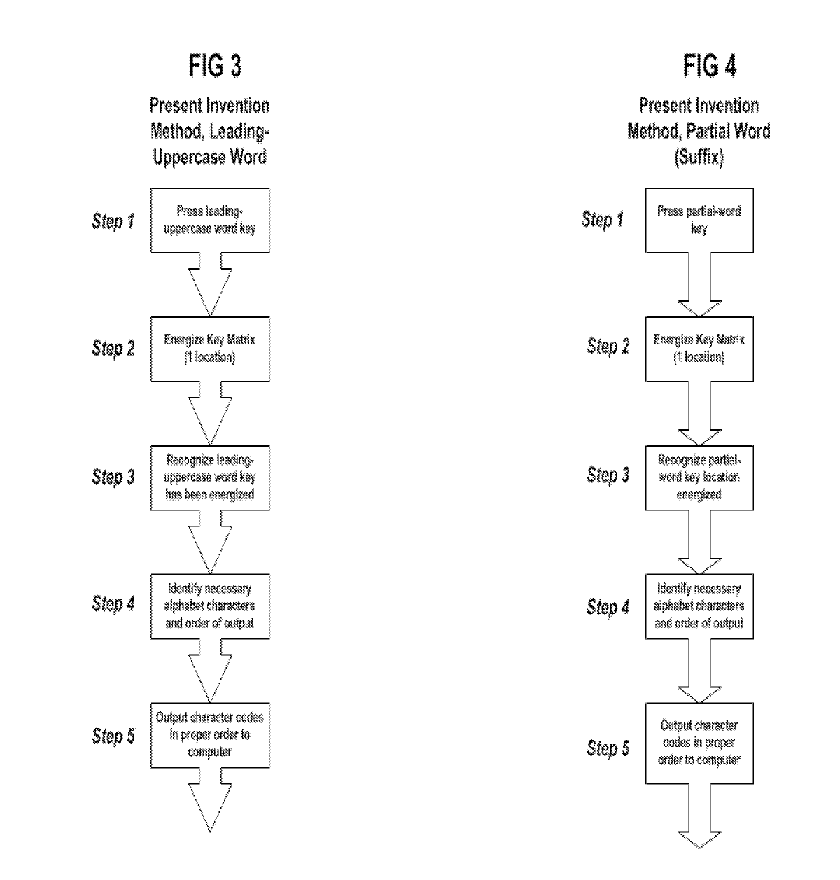

Referring to FIG. 3, Present Invention Method, Leading uppercase word, to output a whole word with the first alphabet character capitalized requires the following steps: A leading-uppercase word key is pressed Step 1 energizing a location on the Key Matrix Step 2. The Processor recognizes that a leading-uppercase word key location has been energized Step 3. The Processor operating program compares that location to a table in the Character Map which identifies the necessary alphabet characters for producing the word Step 4 and identifies the correct output. The Processor then outputs the corresponding character codes for each alphabet character in the correct order to produce the word Step 5.

Referring to FIG. 4, Present Invention Method, Partial-Word (Suffix), to output a suffix requires the following steps: A partial-word key is pressed Step 1 energizing a location on the Key Matrix Step 2. The Processor recognizes that a partial-word key location has been energized Step 3. The Processor operating program compares that location to a table in the Character Map which identifies the necessary alphabet characters for producing the word Step 4 and identifies the correct output. The Processor then outputs the corresponding character codes for each alphabet character in the correct order to produce the partial-word Step 5.

### PREFERRED EMBODIMENT

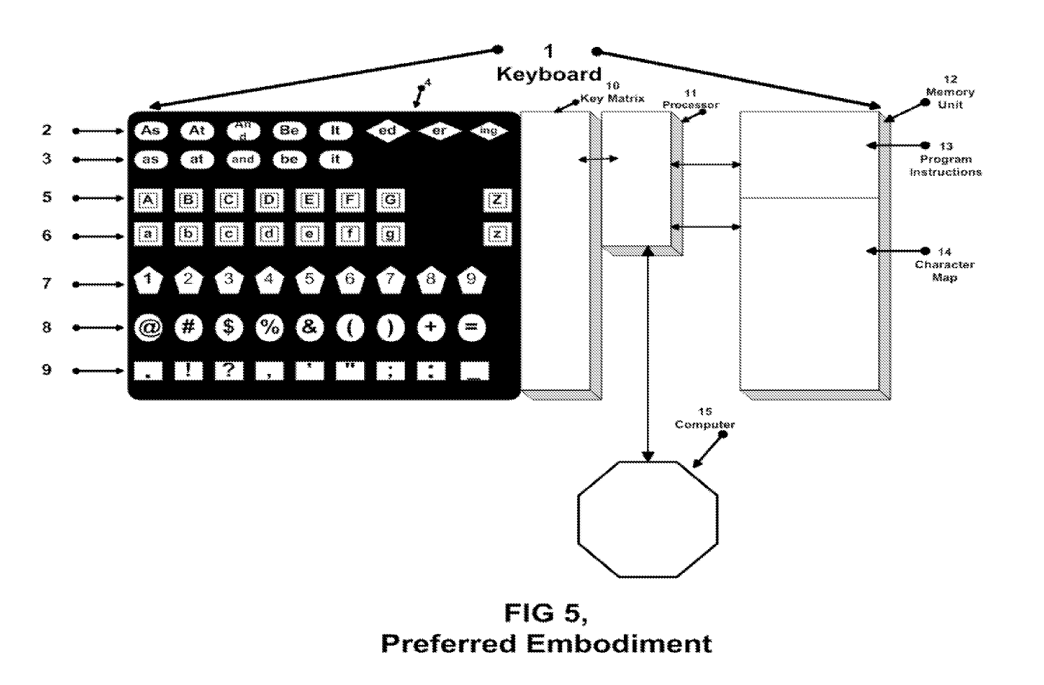

The preferred embodiment of the present invention is a keyboard. FIG. 5 is a partial keyboard and cutaway displaying the pertinent features of the present invention. Referring to FIG. 5, Preferred Embodiment, the keyboard 1 has a separate key for each whole word (leading-uppercase 2 and lowercase 3 versions), each partial word 4, each alphabet character (uppercase 5, alphabetical order in a single row and lowercase 6, alphabetical order in a single row), each number 7, each symbol 8 and each punctuation mark 9. There is an expanded Key Matrix 10 which has a grid location for each character on the keyboard. There is a Processor 11 for processing data input and code output. There is a Memory device 12 containing operating program instructions 13 for the Processor. The Memory also contains an expanded Character Map 14 which has output information for each location on the expanded Key Matrix. That output information is sent to the Processor 11, which then outputs the corrects character codes to a computer 15. As a result of having separate keys for each character, there is no need for the Processor operating program to determine if the Shift key has been pressed in combination with a character key. For example, if the grid location on the Key Matrix corresponds to the $ symbol on the Character Map, the Processor will give the same output as when the Shift key was pressed in combination with the number 4″ key.

### ADDITIONAL EMBODIMENTS

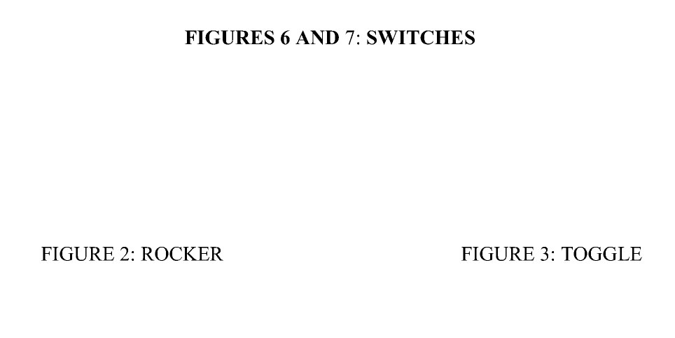

The additional embodiments encompasses the same features and layout of the preferred embodiment, except that standard 2-position (Off-On) push-down key switches are replaced by 3-position switches (On-Off-On). Two types of 3-position switches are considered here: the Rocker-type switch, FIG. 6 and the Toggle-type switch, FIG. 6. They are of a switch class called SPDT (Single Pole, Double Throw) momentary contact switches. They both work in a similar fashion: the normal position of the switch is in the center (Off) position. When the switch is activated in either direction (forward or backward, left or right, top or bottom) a key location is activated and remains activated as long as the operator holds the switch in that position. That is identical to standard key switch operations. When the switch is released, it returns to the center, Off, position.

The difference between these embodiments and the preferred embodiment is that each 3-position can provide two outputs instead of one. An example is that pushing a Toggle key switch forward could produce an uppercase alphabet character, while pulling that same switch backward could produce a lowercase version of that same alphabet character.

### ADVANTAGES AND BENEFITS

The advantages and benefits of the present invention as described for all embodiments are:

a. The present invention eliminates the need for using the Shift key to input data.

b. Visual confusion is reduced

c. One-finger operation of the keyboard is possible.

d. Less steps are required by the Processor program to produce character output.

e. The Caps Lock key, as well as the Caps Lock indicator, can be eliminated.

Consider this example that highlights a major advantage of the present invention: to produce the word editing on most keyboards requires pressing seven keys; one for each alphabet character. Whereas, for the present invention keyboard to produce the same word requires only three key presses: the ed suffix, then the all-lowercase word key it and finally the suffixing. That is a 57% decrease in key presses to produce the same word.

I claim:

1. A method and device to produce character output to a computer or other device independent of the use of key combinations, and to reduce the number of key presses required to operate a computer or other device, comprising:
a. providing a Memory which stores operating program instructions for handling data input and code output, and
b. said memory also containing a Character Map which identifies the appropriate character codes for each character, and
c. said Character Map stores, at individual addresses in said memory, uppercase character codes for producing uppercase versions of alphabet characters, and
d. said Character Map stores, at individual addresses in said memory, lowercase character codes for producing lowercase versions of alphabet characters, and
e. said Character Map stores, at individual addresses in said memory, all-lowercase character codes for producing all-lowercase versions of whole words and
f. said Character Map stores, at individual addresses in said memory, leading-uppercase character codes for producing leading-uppercase words, such as those beginning a sentence, and
g. said Character Map stores, at individual addresses in said memory, character codes for producing partial words such as word endings (suffixes), and
h. said Character Map stores, at individual addresses in said memory, character codes for producing punctuation marks, and
i. said Character Map stores, at individual addresses in said memory, character codes for producing symbols, and
j. said Character Map stores, at individual addresses in said memory, character codes for producing numbers.

2. Providing a Processor which outputs the appropriate character code or codes from the individual addresses in the memory of claim 1.

3. Providing a Keyboard for operator input and code output, comprising:
a. the Memory of claim 1, and
b. said keyboard having a separate key location for each individual address in said memory, and
c. said keyboard having all uppercase alphabet character keys in a separate, single row, and
d. said keyboard having all lowercase alphabet character keys in a separate, single row, and
e. said keyboard providing a Key Matrix which energizes a key location as that particular key location is activated by a key press, and
f. the Processor of claim 2 providing a means to determine and produce the appropriate character code output based on which key location has been energized.
